(19) United States
(12) Patent Application Publication
(10) Pub. No.: US 2019/0004600 A1
(43) Pub. Date: Jan. 3, 2019

(54) METHOD AND ELECTRONIC DEVICE FOR IMAGE DISPLAY

(71) Applicant: LENOVO (BEIJING) CO., LTD., Beijing (CN)

(72) Inventors: Meng WU, Beijing (CN); Xiaopan ZHENG, Beijing (CN)

(21) Appl. No.: 16/021,565

(22) Filed: Jun. 28, 2018

(30) Foreign Application Priority Data
Jun. 28, 2017 (CN) 201710509019.2

(51) Int. Cl. G06F 3/01; G06T 7/70; G06F 3/0481; G02B 27/01

(52) U.S. Cl. CPC G06F 3/013; G06T 7/70; G02B 2027/0138; G02B 27/0172; G02B 2027/0178; G06F 3/04815

(57) ABSTRACT

The present disclosure provides an image display method and an electronic device. The image display method is applied to the electronic device including an image display region. The image display method includes acquiring the eye-movement characteristic information of the user wearing the electronic device, determining a target position according to the eye-movement characteristic information, and adjusting the display position of the image in the image display region from a first position to a second position based on the target position.

### CROSS-REFERENCES TO RELATED APPLICATIONS

This application claims priority of Chinese Patent Application No. 201710509019.2, filed on Jun. 28, 2017, the entire contents of which are hereby incorporated by reference.

### FIELD OF THE DISCLOSURE

The present disclosure generally relates to the field of electronic technology and, more particularly, relates to method and electronic device for image display.

### BACKGROUND

With the continuous development of electronic technology, augmented reality (AR) devices have been more and more widely used. Currently, due to the limited view field of AR devices, the display content is basically fixed at a certain position of the eyeglasses. When a user needs to view different content, the content of the projected image needs to be adjusted through actions such as frequently shaking head, nodding, etc., such that different contents may then be displayed. This indicates that the existing technology cannot display different contents according to the changes in the gazing point of the user's eyes. Therefore, the existing technology does not conform to human's habits of viewing things, and thus the user experience may be poor.

The disclosed image display method and electronic device are directed to solve one or more problems set forth above and other problems.

### BRIEF SUMMARY OF THE DISCLOSURE

One aspect of the present disclosure provides an image display method. The image display method is applied to an electronic device including an image display region. The image display method includes acquiring the eye-movement characteristic information of the user wearing the electronic device, determining a target position according to the eye-movement characteristic information, and adjusting the display position of the image in the image display region from a first position to a second position based on the target position.

Another aspect of the present disclosure provides an electronic device. The electronic device includes an input interface, a first processor, and a display device. The input interface receives the eye-movement characteristic information of a user wearing the electronic device. The first processor determines a target position according to the eye-movement characteristic information. The display device adjusts the display position of the image in the image display region from a first position to a second position based on the target position.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a flowchart of an image display method consistent with some embodiments of the present disclosure;

FIG. 2 illustrates a flowchart of another image display method consistent with some embodiments of the present disclosure;

FIG. 3 illustrates a flowchart of another image display method consistent with some embodiments of the present disclosure;

FIG. 4 illustrates a flowchart of another image display method consistent with some embodiments of the present disclosure;

FIG. 5 illustrates a flowchart of another image display method consistent with some embodiments of the present disclosure;

FIG. 6 illustrates a schematic structural diagram of an electronic device consistent with some embodiments of the present disclosure;

FIG. 7 illustrates a schematic structural diagram of another electronic device consistent with some embodiments of the present disclosure;

FIG. 8 illustrates a schematic structural diagram of another electronic device consistent with some embodiments of the present disclosure;

FIG. 9 illustrates a schematic structural diagram of another electronic device consistent with some embodiments of the present disclosure; and

FIG. 10 illustrates a schematic structural diagram of another electronic device consistent with some embodiments of the present disclosure.

### DETAILED DESCRIPTION

Reference will now be made in detail to various embodiments of the disclosure, which are illustrated in the accompanying drawings. Wherever possible, the same reference numbers will be used throughout the drawings to refer to the same or like parts. The described embodiments are some but not all of the embodiments of the present disclosure. Based on the disclosed embodiments and without inventive efforts, persons of ordinary skill in the art may derive other embodiments consistent with the present disclosure, all of which are within the scope of the present disclosure.

The disclosed embodiments in the present disclosure are merely examples for illustrating the general principles of the disclosure. Any equivalent or modification thereof, without departing from the spirit and principle of the present disclosure, falls within the true scope of the present disclosure.

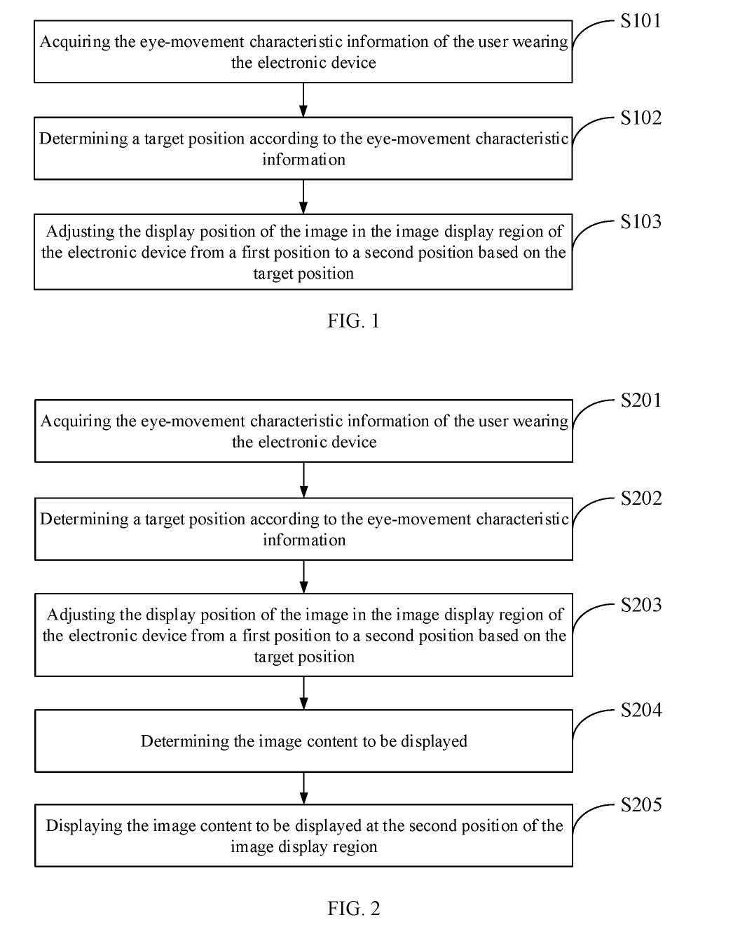

The present disclosure provides an image display method to display different contents according to the changes in the gazing point of the user's eyes. FIG. 1 illustrates a flowchart of an image display method consistent with some embodiments of the present disclosure. The image display method may be applied to an electronic device, and the electronic device may be, for example, wearable smart glasses.

Referring to FIG. 1, in S101, the eye-movement characteristic information of the user wearing the electronic device may be acquired.

In some embodiments, the display mode of the display image of the electronic device may need to be adjusted, the eye-movement characteristic information of the user who wears the electronic device may first be acquired. For example, during the acquisition of the eye-movement characteristic information of the user, the eye-movement characteristic information of the user detected by an eye-movement detection device may be acquired through an input interface of the electronic device. The eye-movement detection device may be a device to acquire the gazing position of the user's eyes, blinks of the user's eyes, etc.

For example, the gazing position of the user's eyes may be determined as follows. A light source may be used to illuminate the user's eyes such that clear reflections from the user's eyes can be generated. Moreover, a video camera may be used to capture the images of the eyes with these reflections. Further, the images captured by the camera may be used to identify the reflections of the light source from the corneas and the pupils of the eyes. The eye-movement vector may then be calculated from the angle between the reflection from the corneas and the reflection from the pupils. Moreover, the direction of the sight may be calculated by combining the direction of the eye-movement vector with other reflective geometric characteristics.

In S102, a target position may be determined according to the eye-movement characteristic information.

After the eye-movement characteristic information of the user who wears the electronic device is acquired, a target position may be determined according to the acquired eye-movement characteristic information. The target position may be a position that the user's eyes are looking at.

In S103, the display position of the image in the image display region of the electronic device may be adjusted from a first position to a second position based on the target position.

After the target position is determined according to the eye-movement characteristic information, the display position of the image in the image display region of the electronic device may be adjusted from a first position to a second position based on the determined target position. The second position may be a position that matches with the target position. In some embodiments, the position matching with the target position is the first position, and accordingly, the first position and the second position may be a same position in the image display region.

Therefore, according to the disclosed method, in order to adjust the display mode of the display image of the electronic device, the eye-movement characteristic information of the user who wears the electronic device is first acquired. Further, a target position is determined according to the eye-movement characteristic information, and then, the display position of the image in the image display region of the electronic device is adjusted from a first position to a second position based on the determined target position. Therefore, the image display method may be able to display an image at different positions according to the changes in the gazing point of the user's eyes. As such, the disclosed image display method may conform to human's habits of viewing things, and thus the user experience may be improved.

FIG. 2 illustrates a flowchart of an image display method consistent with some embodiments of the present disclosure. The image display method may be applied to an electronic device, and the electronic device may be, for example, wearable smart glasses.

Referring to FIG. 2, in S201, the eye-movement characteristic information of the user wearing the electronic device may be acquired.

In some embodiments, the display mode of the display image of the electronic device may need to be adjusted, the eye-movement characteristic information of the user who wears the electronic device may first be acquired. For example, during the acquisition of the eye-movement characteristic information of the user, the eye-movement characteristic information of the user detected by an eye-movement detection device may be acquired through an input interface of the electronic device. The eye-movement detection device may be a device to acquire the gazing position of the user's eyes, blinks of the user's eyes, etc.

For example, the gazing position of the user's eyes may be determined as follows. A light source may be used to illuminate the user's eyes such that clear reflections from the user's eyes can be generated. Moreover, a video camera may be used to capture the images of the eyes with these reflections. Further, the images captured by the camera may be used to identify the reflections of the light source from the corneas and the pupils of the eyes. The eye-movement vector may then be calculated from the angle between the reflection from the corneas and the reflection from the pupils. Moreover, the direction of the sight may be calculated by combining the direction of the eye-movement vector with other reflective geometric characteristics.

In S202, a target position may be determined according to the eye-movement characteristic information.

After the eye-movement characteristic information of the user who wears the electronic device is acquired, a target position may be determined according to the acquired eye-movement characteristic information. The target position may be a position that the user's eyes are looking at.

In S203, the display position of the image in the image display region of the electronic device may be adjusted from a first position to a second position based on the target position.

After the target position is determined according to the eye-movement characteristic information, the display position of the image in the image display region of the electronic device may be adjusted from a first position to a second position based on the determined target position. The second position may be a position that matches with the target position. In some embodiments, the position matching with the target position is the first position, and accordingly, the first position and the second position may be a same position in the image display region.

In S204, the image content to be displayed may be determined.

After the display position of the image in the image display region of the electronic device is adjusted from the first position to the second position based on the target position, the image content to be displayed at the second position may be further determined. For example, the image content to be displayed may be the image content that the user is intended to view at the second position of the image display region.

In S205, the determined image content to be displayed may be displayed at the second position of the image display region.

After the image content to be displayed is determined, the image content to be displayed may then be displayed at the second position of the image display region.

Therefore, compared to the method illustrated in FIG. 1, the method described in FIG. 2 further determines the image content to be displayed, and then displays the determined image content at the second position in the image display region of the electronic device. As such, the user may be able to view the image content that is intended to be displayed at the second position in the image display region of the electronic device.

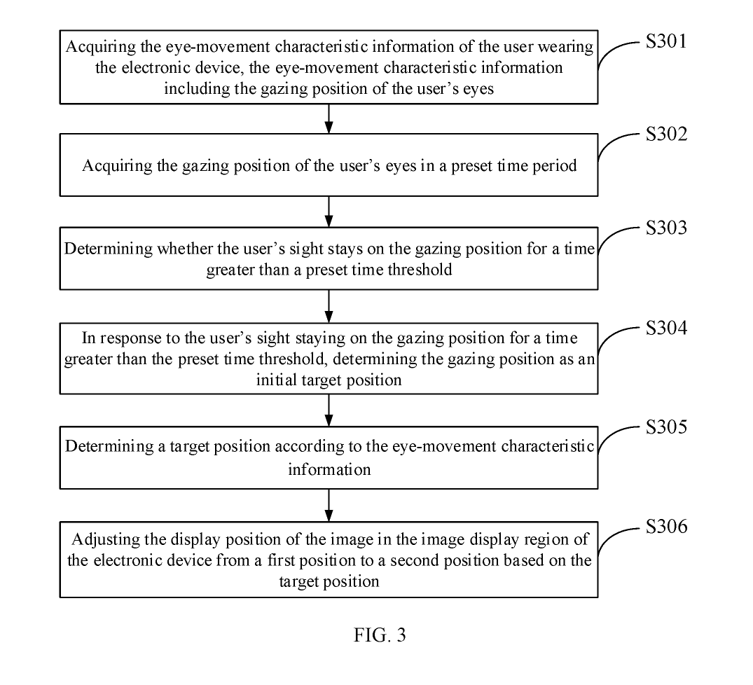

FIG. 3 illustrates a flowchart of an image display method consistent with some embodiments of the present disclosure. The image display method may be applied to an electronic device, and the electronic device may be, for example, wearable smart glasses.

Referring to FIG. 3, in S301, the eye-movement characteristic information of the user wearing the electronic device may be acquired. The eye-movement characteristic information may include the gazing position of the user's eyes.

In some embodiments, the display mode of the display image of the electronic device may need to be adjusted, the eye-movement characteristic information of the user who wears the electronic device may first be acquired. For example, during the acquisition of the eye-movement characteristic information of the user, the eye-movement characteristic information of the user detected by an eye-movement detection device may be acquired through an input interface of the electronic device. The eye-movement detection device may be a device to acquire the gazing position of the user's eyes, blinks of the user's eyes, etc.

For example, the gazing position of the user's eyes may be determined as follows. A light source may be used to illuminate the user's eyes such that clear reflections from the user's eyes can be generated. Moreover, a video camera may be used to capture the images of the eyes with these reflections. Further, the images captured by the camera may be used to identify the reflections of the light source from the corneas and the pupils of the eyes. The eye-movement vector may then be calculated from the angle between the reflection from the corneas and the reflection from the pupils. Moreover, the direction of the sight may be calculated by combining the direction of the eye-movement vector with other reflective geometric characteristics.

In S302, the gazing position of the user's eyes may be acquired in a preset time period.

After the eye-movement characteristic information of the user who wears the electronic device is acquired, the gazing position of the user's eyes may be further acquired in a preset time period. For example, the gazing position of the user's eyes may be acquired in 10 seconds. The preset time period may be determined according to the actual needs of the user.

In S303, whether the user's sight stays on the gazing position for a time greater than a preset time threshold may be determined.

After the gazing position of the user's eyes is acquired in the preset time period, whether the user's sight stays on the gazing position for a time greater than a preset time threshold may be further determined. For example, in a preset time period, the gazing positions of the user's eyes may include position A and position B. Further, whether the user's sight stays on position A and position B for time periods greater than a preset time threshold may be respectively determined. The preset time threshold may be determined according to the actual needs of the user. For example, the preset time threshold may be 5 seconds.

In S304, in response to the user's sight staying on the gazing position for a time greater than the preset time threshold, the gazing position may be determined as an initial target position.

In some embodiments, it is determined that the user's sight stays on the gazing position for a time greater than the preset time threshold, and accordingly, the gazing position may be determined as an initial target position. For example, the user's sight stays on position A for a time greater than the preset time threshold, and thus position A may be determined as an initial target position. Moreover, in the preset time period, the user may gaze on multiple positions for a time period greater than the preset time threshold, and accordingly, multiple initial target positions may thus be determined.

In S305, a target position may be determined according to the eye-movement characteristic information.

After the eye-movement characteristic information of the user who wears the electronic device is acquired, a target position may be determined according to the acquired eye-movement characteristic information. The target position may be a position that the user's eyes are looking at. For example, only one initial target position is determined in a preset time period, the target position may thus be the initial target position as determined in S304. Furthermore, in another example, multiple initial target positions are determined in a preset time period, the target position may be determined as the initial target position with the longest gazing time.

As such, in some embodiments when the eye-movement characteristic information includes a gazing position of the user's eyes, the target position may be determined according to the eye-movement characteristic information as follows, including acquiring the gazing position of the user's eyes in a preset time period; determining whether user's sight stays on the gazing position for a time greater than a preset time threshold; and in response to the user's sight staying on the gazing position for a time greater than the preset time threshold, determining the gazing position as the target position.

In S306, the display position of the image in the image display region of the electronic device may be adjusted from a first position to a second position based on the target position.

After the target position is determined according to the eye-movement characteristic information, the display position of the image in the image display region of the electronic device may be adjusted from a first position to a second position based on the determined target position. The second position may be a position that matches with the target position. In some embodiments, the position matching with the target position is the first position, and accordingly, the first position and the second position may be a same position in the image display region.

Therefore, compared to the method illustrated in FIG. 1, the method described in FIG. 3 further acquires the gazing position of the user's eyes in a preset time period, and then determines whether the user's sight stays on the gazing position for a time greater than a preset time threshold. When the user's sight stays on the gazing position for a time greater than the preset time threshold, the gazing position is determined as an initial target position. Further, the target position may be determined according to the eye-movement characteristic information and the determined initial target position(s). Therefore, by setting the time threshold at which the gazing position stays, the target position may be more effectively determined.

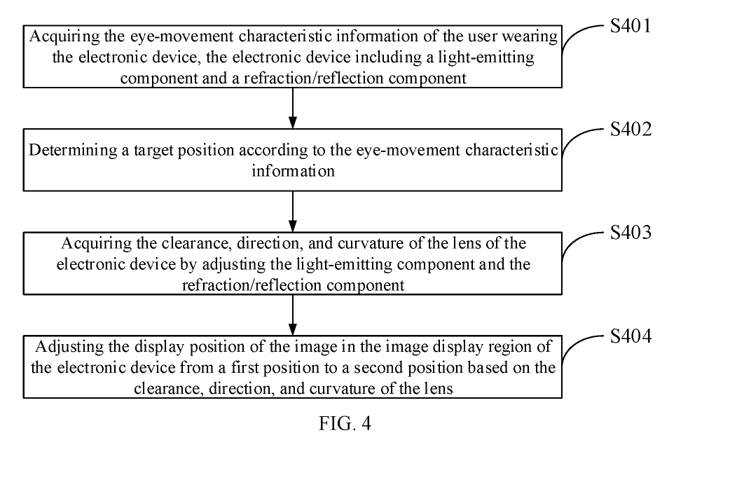

FIG. 4 illustrates a flowchart of an image display method consistent with some embodiments of the present disclosure. The image display method may be applied to an electronic device. The electronic device may include a light-emitting component and a refraction/reflection component. The electronic device may be, for example, wearable smart glasses.

Referring to FIG. 4, in S401, the eye-movement characteristic information of the user wearing the electronic device may be acquired.

In some embodiments, the display mode of the display image of the electronic device may need to be adjusted, the eye-movement characteristic information of the user who wears the electronic device may first be acquired. For example, during the acquisition of the eye-movement characteristic information of the user, the eye-movement characteristic information of the user detected by an eye-movement detection device may be acquired through an input interface of the electronic device. The eye-movement detection device may be a device to acquire the gazing position of the user's eyes, blinks of the user's eyes, etc.

For example, the gazing position of the user's eyes may be determined as follows. A light source may be used to illuminate the user's eyes such that clear reflections from the user's eyes can be generated. Moreover, a video camera may be used to capture the images of the eyes with these reflections. Further, the images captured by the camera may be used to identify the reflections of the light source from the corneas and the pupils of the eyes. The eye-movement vector may then be calculated from the angle between the reflection from the corneas and the reflection from the pupils. Moreover, the direction of the sight may be calculated by combining the direction of the eye-movement vector with other reflective geometric characteristics.

In S402, a target position may be determined according to the eye-movement characteristic information.

After the eye-movement characteristic information of the user who wears the electronic device is acquired, a target position may be determined according to the acquired eye-movement characteristic information. The target position may be a position that the user's eyes are looking at.

In S403, the clearance, direction, and curvature of the lens of the electronic device may be acquired by adjusting the light-emitting component and the refraction/reflection component.

After the target position is determined, the light-emitting component and the refraction/reflection component of the electronic device may be adjusted based on the determined target position such that the clearance, direction, and curvature of the lens of the electronic device may be obtained.

In S404, the display position of the image in the image display region of the electronic device may be adjusted from a first position to a second position based on the clearance, direction, and curvature of the lens.

In some embodiments, the display position of the image in the image display region of the electronic device may be adjusted from a first position to a second position based on the acquired clearance, direction, and curvature of the lens of the electronic device.

Therefore, compared to the method illustrated in FIG. 1, the method described in FIG. 4 further acquires the clearance, direction, and curvature of the lens of the electronic device by adjusting a light-emitting component and a refraction/reflection component, and then adjusts the display position of the image in the image display region from the first position to the second position based on the clearance, direction, and curvature of the lens.

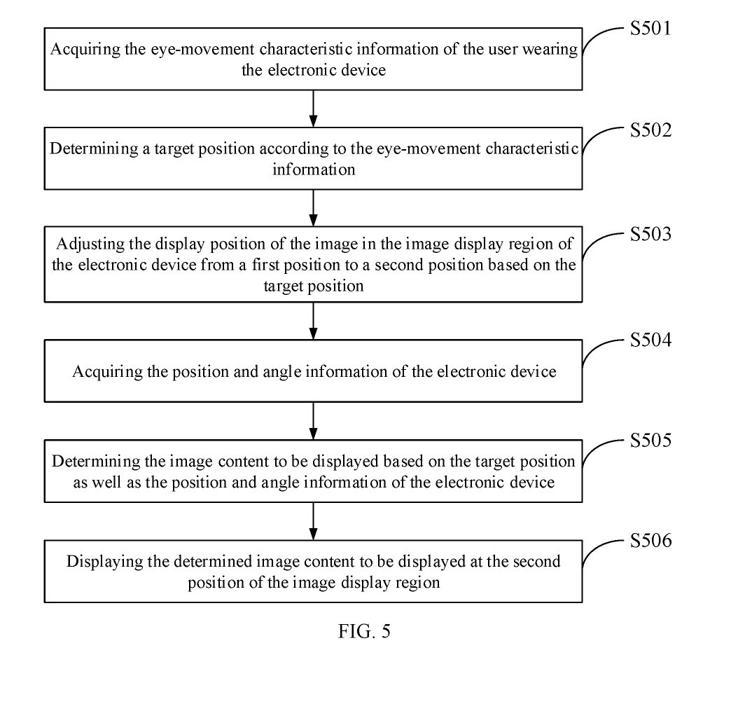

FIG. 5 illustrates a flowchart of an image display method consistent with some embodiments of the present disclosure. The image display method may be applied to an electronic device, and the electronic device may be, for example, wearable smart glasses.

Referring to FIG. 5, in S501, the eye-movement characteristic information of the user wearing the electronic device may be acquired.

In some embodiments, the display mode of the display image of the electronic device may need to be adjusted, the eye-movement characteristic information of the user who wears the electronic device may first be acquired. For example, during the acquisition of the eye-movement characteristic information of the user, the eye-movement characteristic information of the user detected by an eye-movement detection device may be acquired through an input interface of the electronic device. The eye-movement detection device may be a device to acquire the gazing position of the user's eyes, blinks of the user's eyes, etc.

For example, the gazing position of the user's eyes may be determined as follows. A light source may be used to illuminate the user's eyes such that clear reflections from the user's eyes can be generated. Moreover, a video camera may be used to capture the images of the eyes with these reflections. Further, the images captured by the camera may be used to identify the reflections of the light source from the corneas and the pupils of the eyes. The eye-movement vector may then be calculated from the angle between the reflection from the corneas and the reflection from the pupils. Moreover, the direction of the sight may be calculated by combining the direction of the eye-movement vector with other reflective geometric characteristics.

In S502, a target position may be determined according to the eye-movement characteristic information.

After the eye-movement characteristic information of the user who wears the electronic device is acquired, a target position may be determined according to the acquired eye-movement characteristic information. The target position may be a position that the user's eyes are looking at.

In S503, the display position of the image in the image display region of the electronic device may be adjusted from a first position to a second position based on the target position.

After the target position is determined according to the eye-movement characteristic information, the display position of the image in the image display region of the electronic device may be adjusted from a first position to a second position based on the determined target position. The second position may be a position that matches with the target position. In some embodiments, the position matching with the target position is the first position, and accordingly, the first position and the second position may be a same position in the image display region.

In S504, the position and angle information of the electronic device may be acquired.

In some embodiments, the position and angle information of the electronic device may be acquired. For example, the tilt angle of the electronic device may be acquired.

In S505, the image content to be displayed may be determined based on the target position as well as the position and angle information of the electronic device.

After the display position of the image in the image display region is adjusted from the first position to the second position based on the target position, the image content that needs to be displayed at the second position may be further determined. During the determination of the image content that needs to be displayed at the second position, the determination may be based on the acquired position and angle information of the electronic device, such as the tilt angle of the electronic device, etc. The image content to be displayed may thus be determined based on the position and angle information of the electronic device and the target position.

In S506, the determined image content to be displayed may be displayed at the second position of the image display region.

After the image content to be displayed is determined, the image content to be displayed may then be displayed at the second position of the image display region.

Therefore, compared to the method illustrated in FIG. 2, the method described in FIG. 5 further acquires the position and angle information of the electronic device, and then uses the specific position of the electronic device and the target position to jointly determine the image content to be displayed such that desired visual effect may be achieved.

The present disclosure also provides an electronic device to display different contents according to the changes in the gazing point of the user's eyes. FIG. 6 illustrates a schematic structural diagram of an electronic device consistent with some embodiments of the present disclosure. The electronic device may be, for example, wearable smart glasses.

Referring to FIG. 6, the electronic device may include an input interface 601. The input interface 601 may receive the eye-movement characteristic information of the user wearing the electronic device.

In some embodiments, the display mode of the display image of the electronic device may need to be adjusted, the eye-movement characteristic information of the user who wears the electronic device may first be acquired. For example, during the acquisition of the eye-movement characteristic information of the user, the eye-movement characteristic information of the user detected by an eye-movement detection device may be acquired through the input interface 601 of the electronic device. The eye-movement detection device may be a device to acquire the gazing position of the user's eyes, blinks of the user's eyes, etc.

For example, the gazing position of the user's eyes may be determined as follows. A light source may be used to illuminate the user's eyes such that clear reflections from the user's eyes can be generated. Moreover, a video camera may be used to capture the images of the eyes with these reflections. Further, the images captured by the camera may be used to identify the reflections of the light source from the corneas and the pupils of the eyes. The eye-movement vector may then be calculated from the angle between the reflection from the corneas and the reflection from the pupils. Moreover, the direction of the sight may be calculated by combining the direction of the eye-movement vector with other reflective geometric characteristics.

The electronic device may also include a first processor 602. The first processor 602 may determine a target position according to the eye-movement characteristic information.

After the eye-movement characteristic information of the user who wears the electronic device is acquired, the first processor 602 may determine a target position according to the acquired eye-movement characteristic information. The target position may be a position that the user's eyes are looking at.

The electronic device may further include a display device 603. The display device 603 may adjust the display position of the image in the image display region from a first position to a second position based on the target position.

After the target position is determined according to the eye-movement characteristic information, the display device 603 may adjust the display position of the image in the image display region of the electronic device from a first position to a second position based on the determined target position. The second position may be a position that matches with the target position. In some embodiments, the position matching with the target position is the first position, and accordingly, the first position and the second position may be a same position in the image display region.

Therefore, according to the disclosed electronic device, in order to adjust the display mode of the display image of the electronic device, the eye-movement characteristic information of the user who wears the electronic device is first acquired. Further, a target position is determined according to the eye-movement characteristic information, and then, the display position of the image in the image display region of the electronic device is adjusted from a first position to a second position based on the determined target position. Therefore, the image display method may be able to display an image at different positions according to the changes in the gazing point of the user's eyes. As such, the disclosed image display method may conform to human's habits of viewing things, and thus the user experience may be improved.

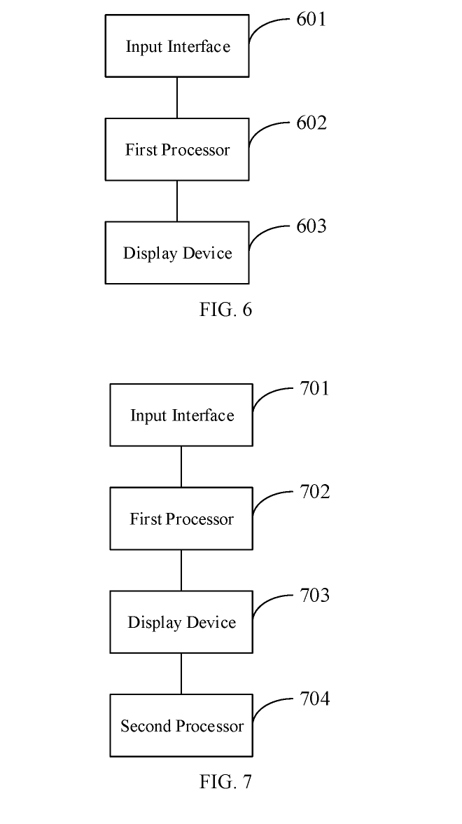

FIG. 7 illustrates a schematic structural diagram of an electronic device consistent with some embodiments of the present disclosure. The electronic device may be, for example, wearable smart glasses.

Referring to FIG. 7, the electronic device may include an input interface 701. The input interface 701 may receive the eye-movement characteristic information of the user wearing the electronic device.

In some embodiments, the display mode of the display image of the electronic device may need to be adjusted, the eye-movement characteristic information of the user who wears the electronic device may first be acquired. For example, during the acquisition of the eye-movement characteristic information of the user, the eye-movement characteristic information of the user detected by an eye-movement detection device may be acquired through the input interface 701 of the electronic device. The eye-movement detection device may be a device to acquire the gazing position of the user's eyes, blinks of the user's eyes, etc.

For example, the gazing position of the user's eyes may be determined as follows. A light source may be used to illuminate the user's eyes such that clear reflections from the user's eyes can be generated. Moreover, a video camera may be used to capture the images of the eyes with these reflections. Further, the images captured by the camera may be used to identify the reflections of the light source from the corneas and the pupils of the eyes. The eye-movement vector may then be calculated from the angle between the reflection from the corneas and the reflection from the pupils. Moreover, the direction of the sight may be calculated by combining the direction of the eye-movement vector with other reflective geometric characteristics.

The electronic device may also include a first processor 702. The first processor 702 may determine a target position according to the eye-movement characteristic information.

After the eye-movement characteristic information of the user who wears the electronic device is acquired, the first processor 702 may determine a target position according to the acquired eye-movement characteristic information. The target position may be a position that the user's eyes are looking at.

The electronic device may also include a display device 703. The display device 703 may adjust the display position of the image in the image display region from a first position to a second position based on the target position.

After the target position is determined according to the eye-movement characteristic information, the display device 703 may adjust the display position of the image in the image display region of the electronic device from a first position to a second position based on the determined target position. The second position may be a position that matches with the target position. In some embodiments, the position matching with the target position is the first position, and accordingly, the first position and the second position may be a same position in the image display region.

The electronic device may further include a second processor 704. The second processor 704 may determine the image content to be displayed.

After the display position of the image in the image display region of the electronic device is adjusted from the first position to the second position based on the target position, the second processor 704 may further determine image content to be displayed at the second position. The image content to be displayed may be the image content that the user is intended to view at the second position of the image display region.

Further, the display device 703 may also display the determined image content at the second position of the image display region.

In some embodiments, the image content to be displayed is determined by the second processor 704, the display device 703 may display the determined image content at the second position of the image display region.

Therefore, compared to the electronic device illustrated in FIG. 6, the electronic device described in FIG. 7 further determines the image content to be displayed, and then displays the determined image content at the second position in the image display region of the electronic device. As such, the user may be able to view the image content that is intended to be displayed at the second position in the image display region of the electronic device.

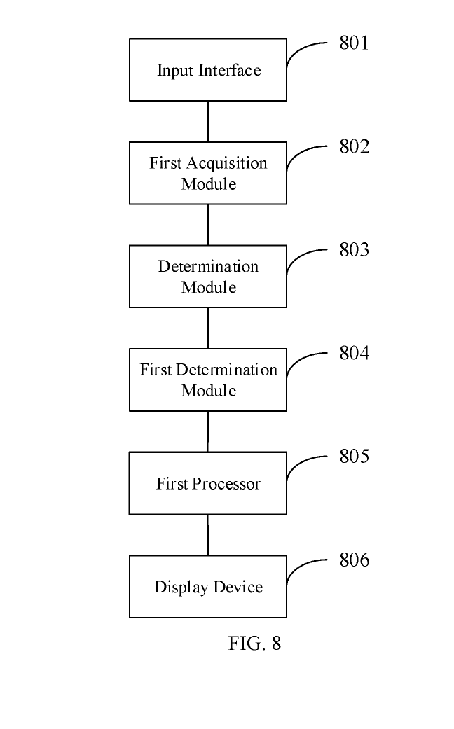

FIG. 8 illustrates a schematic structural diagram of an electronic device consistent with some embodiments of the present disclosure. The electronic device may be, for example, wearable smart glasses.

Referring to FIG. 8, the electronic device may include an input interface 801. The input interface 801 may acquire the eye-movement characteristic information of the user wearing the electronic device. The eye-movement characteristic information may include the gazing position of the user's eyes.

In some embodiments, the display mode of the display image of the electronic device may need to be adjusted, the eye-movement characteristic information of the user who wears the electronic device may first be acquired. For example, during the acquisition of the eye-movement characteristic information of the user, the eye-movement characteristic information of the user detected by an eye-movement detection device may be acquired through the input interface 801 of the electronic device. The eye-movement detection device may be a device to acquire the gazing position of the user's eyes, blinks of the user's eyes, etc. For example, the gazing position of the user's eyes may be determined as follows. A light source may be used to illuminate the user's eyes such that clear reflections from the user's eyes can be generated. Moreover, a video camera may be used to capture the images of the eyes with these reflections. Further, the images captured by the camera may be used to identify the reflections of the light source from the corneas and the pupils of the eyes. The eye-movement vector may then be calculated from the angle between the reflection from the corneas and the reflection from the pupils. Moreover, the direction of the sight may be calculated by combining the direction of the eye-movement vector with other reflective geometric characteristics.

The electronic device may also include a first acquisition module 802. The first acquisition module 802 may acquire the gazing position of the user's eyes in a preset time period.

After the eye-movement characteristic information of the user who wears the electronic device is acquired, the first acquisition module 802 may acquire the gazing position of the user's eyes in a preset time period. For example, the gazing position of the user's eyes may be acquired in 10 seconds. The preset time period may be determined according to the actual needs of the user.

The electronic device may also include a determination module 803. The determination module 803 may determine whether the user's sight stays on the gazing position for a time greater than a preset time threshold.

After the gazing position of the user's eyes is acquired in the preset time period, the determination module 803 may determine whether the user's sight stays on the gazing position for a time greater than a preset time threshold. For example, in a preset time period, the gazing positions of the user's eyes may include position A and position B. Further, whether the user's sight stays on position A and position B for time periods greater than a preset time threshold may be respectively determined. The preset time threshold may be determined according to the actual needs of the user. For example, the preset time threshold may be 5 seconds.

The electronic device may also include a first determination module 804. The first determination module 804 may determine the gazing position as an initial target position in response to the user's sight staying on the gazing position for a time greater than the preset time threshold.

In some embodiments, it is determined that the user's sight stays on the gazing position for a time greater than the preset time threshold, and accordingly, the first determination module 804 may determine the gazing position as an initial target position. For example, the user's sight stays on position A for a time greater than the preset time threshold, and thus position A may be determined as an initial target position. Moreover, in the preset time period, the user may gaze on multiple positions for a time period greater than the preset time threshold, and accordingly, multiple initial target positions may thus be determined.

The electronic device may also include a first processor 805. The first processor 805 may determine a target position according to the eye-movement characteristic information.

After the eye-movement characteristic information of the user who wears the electronic device is acquired, the first processor 805 may determine a target position according to the acquired eye-movement characteristic information. The target position may be a position that the user's eyes are looking at. For example, only one initial target position is determined in a preset time period, the target position may thus be the initial target position as determined by the first determination module 804. Furthermore, in another example, multiple initial target positions are determined in a preset time period, the target position may be determined as the initial target position with the longest gazing time.

As such, in some embodiments when the eye-movement characteristic information includes a gazing position of the user's eyes, the target position may be determined according to the eye-movement characteristic information as follows, including acquiring the gazing position of the user's eyes in a preset time period; determining whether user's sight stays on the gazing position for a time greater than a preset time threshold; and in response to the user's sight staying on the gazing position for a time greater than the preset time threshold, determining the gazing position as the target position.

The electronic device may also include a display device 806. The display device 806 may adjust the display position of the image in the image display region of the electronic device from a first position to a second position based on the target position.

After the target position is determined according to the eye-movement characteristic information, the display device 806 may adjust the display position of the image in the image display region of the electronic device from a first position to a second position based on the determined target position. The second position may be a position that matches with the target position. In some embodiments, the position matching with the target position is the first position, and accordingly, the first position and the second position may be a same position in the image display region.

Therefore, compared to the electronic device illustrated in FIG. 6, the electronic device described in FIG. 8 further acquires the gazing position of the user's eyes in a preset time period, and then determines whether the user's sight stays on the gazing position for a time greater than a preset time threshold. When the user's sight stays on the gazing position for a time greater than the preset time threshold, the gazing position is determined as an initial target position. Further, the target position may be determined according to the eye-movement characteristic information and the determined initial target position(s). Therefore, by setting the time threshold at which the gazing position stays, the target position may be more effectively determined

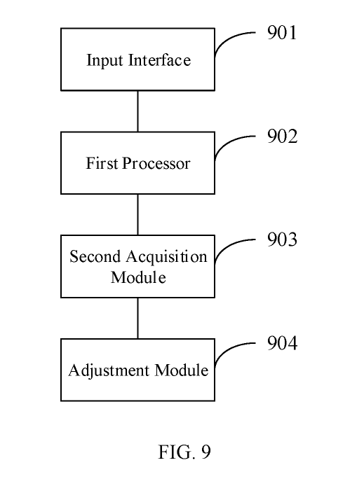

FIG. 9 illustrates a schematic structural diagram of an electronic device consistent with some embodiments of the present disclosure. The electronic device may include a light-emitting component and a refraction/reflection component. The electronic device may be, for example, wearable smart glasses.

Referring to FIG. 9, the electronic device may include an input interface 901. The input interface 901 may acquire the eye-movement characteristic information of the user wearing the electronic device.

In some embodiments, the display mode of the display image of the electronic device may need to be adjusted, the eye-movement characteristic information of the user who wears the electronic device may first be acquired. For example, during the acquisition of the eye-movement characteristic information of the user, the eye-movement characteristic information of the user detected by an eye-movement detection device may be acquired through the input interface 901 of the electronic device. The eye-movement detection device may be a device to acquire the gazing position of the user's eyes, blinks of the user's eyes, etc.

For example, the gazing position of the user's eyes may be determined as follows. A light source may be used to illuminate the user's eyes such that clear reflections from the user's eyes can be generated. Moreover, a video camera may be used to capture the images of the eyes with these reflections. Further, the images captured by the camera may be used to identify the reflections of the light source from the corneas and the pupils of the eyes. The eye-movement vector may then be calculated from the angle between the reflection from the corneas and the reflection from the pupils. Moreover, the direction of the sight may be calculated by combining the direction of the eye-movement vector with other reflective geometric characteristics.

The electronic device may also include a first processor 902. The first processor 902 may determine a target position according to the eye-movement characteristic information.

After the eye-movement characteristic information of the user who wears the electronic device is acquired, the first processor may determine a target position according to the acquired eye-movement characteristic information. The target position may be a position that the user's eyes are looking at.

The electronic device may include a second acquisition module 903. The second acquisition module 903 may adjust the light-emitting component and the refraction/reflection component and acquire the clearance, direction, and curvature of the lens of the electronic device.

After the target position is determined, the second acquisition module 903 may adjust the light-emitting component and the refraction/reflection component of the electronic device, based on the determined target position, and thus acquire the clearance, direction, and curvature of the lens of the electronic device.

The electronic device may include an adjustment module 904. The adjustment module 904 may adjust the display position of the image in the image display region of the electronic device from a first position to a second position based on the clearance, direction, and curvature of the lens.

In some embodiments, the adjustment module 904 may adjust the display position of the image in the image display region of the electronic device from a first position to a second position based on the acquired clearance, direction, and curvature of the lens of the electronic device.

Therefore, compared to the electronic device illustrated in FIG. 6, the electronic device described in FIG. 9 further acquires the clearance, direction, and curvature of the lens of the electronic device by adjusting a light-emitting component and a refraction/reflection component, and then adjusts the display position of the image in the image display region from the first position to the second position based on the clearance, direction, and curvature of the lens.

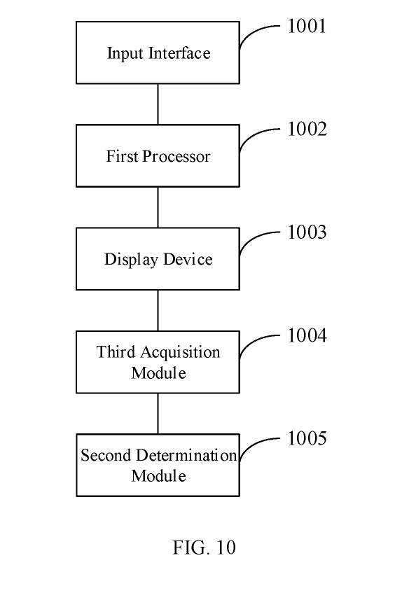

FIG. 10 illustrates a schematic structural diagram of an electronic device consistent with some embodiments of the present disclosure. The electronic device may be, for example, wearable smart glasses.

Referring to FIG. 10, the electronic device may include an input interface 1001. The input interface 1001 may acquire the eye-movement characteristic information of the user wearing the electronic device.

In some embodiments, the display mode of the display image of the electronic device may need to be adjusted, the eye-movement characteristic information of the user who wears the electronic device may first be acquired. For example, during the acquisition of the eye-movement characteristic information of the user, the eye-movement characteristic information of the user detected by an eye-movement detection device may be acquired through the input interface 1001 of the electronic device. The eye-movement detection device may be a device to acquire the gazing position of the user's eyes, blinks of the user's eyes, etc.

For example, the gazing position of the user's eyes may be determined as follows. A light source may be used to illuminate the user's eyes such that clear reflections from the user's eyes can be generated. Moreover, a video camera may be used to capture the images of the eyes with these reflections. Further, the images captured by the camera may be used to identify the reflections of the light source from the corneas and the pupils of the eyes. The eye-movement vector may then be calculated from the angle between the reflection from the corneas and the reflection from the pupils. Moreover, the direction of the sight may be calculated by combining the direction of the eye-movement vector with other reflective geometric characteristics.

The electronic device may also include a first processor 1002. The first processor 1002 may determine a target position according to the eye-movement characteristic information.

After the eye-movement characteristic information of the user who wears the electronic device is acquired, the first processor 1002 may determine a target position according to the acquired eye-movement characteristic information. The target position may be a position that the user's eyes are looking at.

The electronic device may also include a display device 1003. The display device 1003 may adjust the display position of the image in the image display region of the electronic device from a first position to a second position based on the target position.

After the target position is determined according to the eye-movement characteristic information, the display device 1003 may adjust the display position of the image in the image display region of the electronic device from a first position to a second position based on the determined target position. The second position may be a position that matches with the target position. In some embodiments, the position matching with the target position is the first position, and accordingly, the first position and the second position may be a same position in the image display region.

The electronic device may also include a third acquisition module 1004. The third acquisition module 1004 may acquire the position and angle information of the electronic device.

In some embodiments, the third acquisition module 1004 may acquire the position and angle information of the electronic device. For example, the third acquisition module 1004 may acquire the tilt angle of the electronic device.

The electronic device may further include a second determination module 1005. The second determination module 1005 may determine the image content to be displayed based on the target position as well as the position and angle information of the electronic device.

After the display position of the image in the image display region is adjusted from the first position to the second position based on the target position, the second determination module 1005 may further determine the image content that needs to be displayed at the second position. During the determination of the image content that needs to be displayed at the second position, the determination may be based on the acquired position and angle information of the electronic device, such as the tilt angle of the electronic device, etc. The image content to be displayed may thus be determined based on the position and angle information of the electronic device and the target position.

Further, the display device 1003 may also display the determined image content to be displayed at the second position of the image display region.

In some embodiments, after the image content to be displayed is determined, the display device 1003 may display the image content to be displayed at the second position of the image display region.

Therefore, compared to the electronic device illustrated in FIG. 7, the electronic device described in FIG. 10 further acquires the position and angle information of the electronic device, and then uses the specific position of the electronic device and the target position to jointly determine the image content to be displayed such that desired visual effect may be achieved.

Compared to existing image display methods and electronic devices, the disclosed image display methods and electronic devices may demonstrate several advantages.

According to the disclosed image display methods and electronic devices, the eye-movement characteristic information of the user wearing the electronic device is acquired first, and a target position is then determined according to the eye-movement characteristic information. Further, the display position of the image in the image display region of the electronic device is adjusted from a first position to a second position based on the target position. The disclosed image display methods and electronic device may be able to display an image at different positions according to the changes in the gazing point of the user's eyes. As such, the disclosed image display method may conform to human's habits of viewing things, and thus the user experience may be improved.

The embodiments provided in the present disclosure are described in a progressive manner. Each embodiment focuses on the differences from other embodiments, and the same or similar parts among these embodiments may be referred to each other. For the devices disclosed in the embodiments, the description may be relatively simple because of the corresponding relation between the devices and the disclosed methods. The details of the disclosed devices may be referred to the corresponding content in the description of the methods.

Those skilled in the art may further realize that the units and algorithm steps of the examples described with reference to the embodiments disclosed herein can be implemented by electronic hardware, computer software, or a combination of the two. To clearly illustrate the interchangeability of hardware and software, the components and steps of various examples have been generally described in terms of their functionality. Whether these functions are implemented by hardware or software depends on the specific application and the design constraints of the technical solutions. A person skilled in the art may use different methods to implement the described functions for each particular application. However, such implementation should not be considered as beyond the scope of the present disclosure.

The steps of the method or algorithm described in the embodiments disclosed herein may be implemented directly by hardware, a processor-executable software module, or a combination of the two. The software module may be located in random access memories (RAMs), internal memories, read-only memories (ROMs), electrically programmable ROMs, electrically erasable programmable ROM, registers, hard disks, removable disks, CD-ROMs, or other storage media that are well known in the field.

The description of the disclosed embodiments provided above ensures that those skilled in the art can realize or use the present disclosure. Various modifications to the embodiments are readily apparent to those skilled in the art. The general principles herein may be implemented in other embodiments without departing from the spirit or scope of the disclosure. Therefore, the present disclosure should not be limited to these embodiments described herein, but rather should be in accordance with the broadest scope consistent with the principles and the novel features disclosed herein.

What is claimed is:

1. An image display method, comprising:
acquiring eye-movement characteristic information of a user wearing an electronic device, the electronic device including an image display region;
determining a target position according to the eye-movement characteristic information; and
adjusting a display position of an image in the image display region from a first position to a second position based on the target position.

2. The image display method according to claim 1, further including:
determining image content to be displayed; and
displaying the image content to be displayed at the second position in the image display region.

3. The image display method according to claim 1, wherein:
the eye-movement characteristic information includes a gazing position of the user's eyes, and
determining the target position according to the eye-movement characteristic information includes:
acquiring the gazing position of the user's eyes in a preset time period;
determining whether user's sight stays on the gazing position for a time greater than a preset time threshold; and
in response to the user's sight staying on the gazing position for a time greater than the preset time threshold, determining the gazing position as the target position.

4. The image display method according to claim 1, wherein:
the electronic device also includes a light-emitting component and a refraction/reflection component, and
adjusting the display position of the image in the image display region from the first position to the second position based on the target position includes:
acquiring clearance, direction, and curvature of a lens of the electronic device by adjusting the light-emitting component and the refraction/reflection component; and
adjusting the display position of the image in the image display region from the first position to the second position based on the clearance, direction, and curvature of the lens.

5. The image display method according to claim 2, wherein determining the image content to be displayed includes:
acquiring position and angle information of the electronic device; and
determining the image content to be displayed based on the target position as well as the position and angle information of the electronic device.

6. An electronic device, comprising:
an input interface;
a first processor; and
a display device, wherein:
the input interface receives eye-movement characteristic information of a user wearing the electronic device,
the first processor determines a target position according to the eye-movement characteristic information, and
the display device adjusts a display position of an image in an image display region of the electronic device from a first position to a second position based on the target position.

7. The electronic device according to claim 6, further including:
a second processor, that determines image content to be displayed, wherein,
the display device displays the image content to be displayed at the second position in the image display region.

8. The electronic device according to claim 6, wherein:
the eye-movement characteristic information includes a gazing position of the user's eyes, and
the first processor acquires the gazing position of the user's eyes in a preset time period, determination module determines whether user's sight stays on the gazing position for a time greater than a preset time threshold; and determines the gazing position as the target position in response to the user's sight staying on the gazing position for a time greater than the preset time threshold.

9. The electronic device according to claim 6, further including:
a light-emitting component and a refraction/reflection component, and
the display device acquires clearance, direction, and curvature of a lens of the electronic device by adjusting the light-emitting component and the refraction/reflection component, and adjusts the display position of the image in the image display region from the first position to the second position based on the clearance, direction, and curvature of the lens.

10. The electronic device according to claim 7, wherein:
the second processor acquires position and angle information of the electronic device, and determines the image content to be displayed based on the target position as well as the position and angle information of the electronic device.
